(19) United States
(12) Patent Application Publication
(10) Pub. No.: US 2002/0180148 A1
(43) Pub. Date: Dec. 5, 2002

(54) Remote control with hand and finger cushions

(76) Inventor: John Koziel, Lake Zurich, IL (US)

Correspondence Address: Richard W. Goldstein, 2071 Clove Road, Staten Island, NY, 10304, US

(21) Appl. No.: 09/872,026

(22) Filed: Jun. 1, 2001

(51) Int. Cl. A63F 13/02

(52) U.S. Cl. 273/148 B

(57) ABSTRACT

A remote control with hand and finger cushions including a control portion having a generally inverted U-shaped configuration. The control portion has a horizontal segment and a pair of downwardly depending vertical segments. The vertical segments serve as hand grips. The horizontal segment has a plurality of game controls disposed thereon. The game controls are in communication with circuitry disposed interiorly of the control portion. Each of the game controls is defined by a pressable button. Padding is coupled with respect to the control portion.

### BACKGROUND OF THE INVENTION

The present invention relates to a remote control with hand and finger cushions and more particularly pertains to cushioning the hand and fingers while using a remote control.

The use of finger protection devices is known in the prior art. More specifically, finger protection devices heretofore devised and utilized for the purpose of providing protection to the fingers are known to consist basically of familiar, expected and obvious structural configurations, notwithstanding the myriad of designs encompassed by the crowded prior art which have been developed for the fulfillment of countless objectives and requirements.

By way of example, U.S. Pat. No. 6,009,557 to Witta discloses a video game control glove with means for protecting the thumb and forefingers of the player's hand. U.S. Pat. No. 4,519,097 to Chappell, Jr. discloses a video game protective glove leaving the fingertips exposed for maintaining sensitivity. U.S Pat. Nos. Des. 280,053 to Singer and Des. 270,631 to Moskin disclose ornamental designs for a video glove and controller respectively.

While these devices fulfill their respective, particular objective and requirements, the aforementioned patents do not describe a remote control with hand and finger cushions for cushioning the hand and fingers while using a remote control.

In this respect, the remote control with hand and finger cushions according to the present invention substantially departs from the conventional concepts and designs of the prior art, and in doing so provides an apparatus primarily developed for the purpose of cushioning the hand and fingers while using a remote control.

Therefore, it can be appreciated that there exists a continuing need for a new and improved remote control with hand and finger cushions which can be used for cushioning the hand and fingers while using a remote control. In this regard, the present invention substantially fulfills this need.

### SUMMARY OF THE INVENTION

In the view of the foregoing disadvantages inherent in the known types of finger protection devices now present in the prior art, the present invention provides an improved remote control with hand and finger cushions. As such, the general purpose of the present invention, which will be described subsequently in greater detail, is to provide a new and improved remote control with hand and finger cushions which has all the advantages of the prior art and none of the disadvantages.

To attain this, the present invention essentially comprises a control portion having a generally inverted U-shaped configuration. The control portion has a horizontal segment and a pair of downwardly depending vertical segments. The vertical segments serve as hand grips. The horizontal segment has a plurality of game controls disposed thereon. The game controls are in communication with circuitry disposed interiorly of the control portion. Each of the game controls is defined by a pressable button. Padding is coupled with respect to the control portion. The padding includes a pair of sleeves receiving the vertical segments therein. The padding includes individual pads disposed on the pressable buttons of the game controls.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved remote control with hand and finger cushions which has all the advantages of the prior art finger protection devices and none of the disadvantages.

It is another object of the present invention to provide a new and improved remote control with hand and finger cushions which may be easily and efficiently manufactured and marketed.

It is a further object of the present invention to provide a new and improved remote control with hand and finger cushions which is of durable and reliable construction.

An even further object of the present invention is to provide a new and improved remote control with hand and finger cushions which is susceptible of a low cost of manufacture with regard to both materials and labor, and which accordingly is then susceptible of low prices of sale to the consuming public, thereby making such a remote control with hand and finger cushions economically available to the buying public.

Even still another object of the present invention is to provide a new and improved remote control with hand and finger cushions for cushioning the hand and fingers while using a remote control.

Lastly, it is an object of the present invention to provide a new and improved remote control with hand and finger cushions including a control portion having a generally inverted U-shaped configuration. The control portion has a horizontal segment and a pair of downwardly depending vertical segments. The vertical segments serve as hand grips. The horizontal segment has a plurality of game controls disposed thereon. The game controls are in communication with circuitry disposed interiorly of the control portion. Each of the game controls is defined by a pressable button. Padding is coupled with respect to the control portion.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a plan view of the preferred embodiment of the remote control with hand and finger cushions constructed in accordance with the principles of the present invention.

FIG. 2 is an elevated side view of the present invention.

The same reference numerals refer to the same parts through the various figures.

### DESCRIPTION OF THE PREFERRED EMBODIMENT

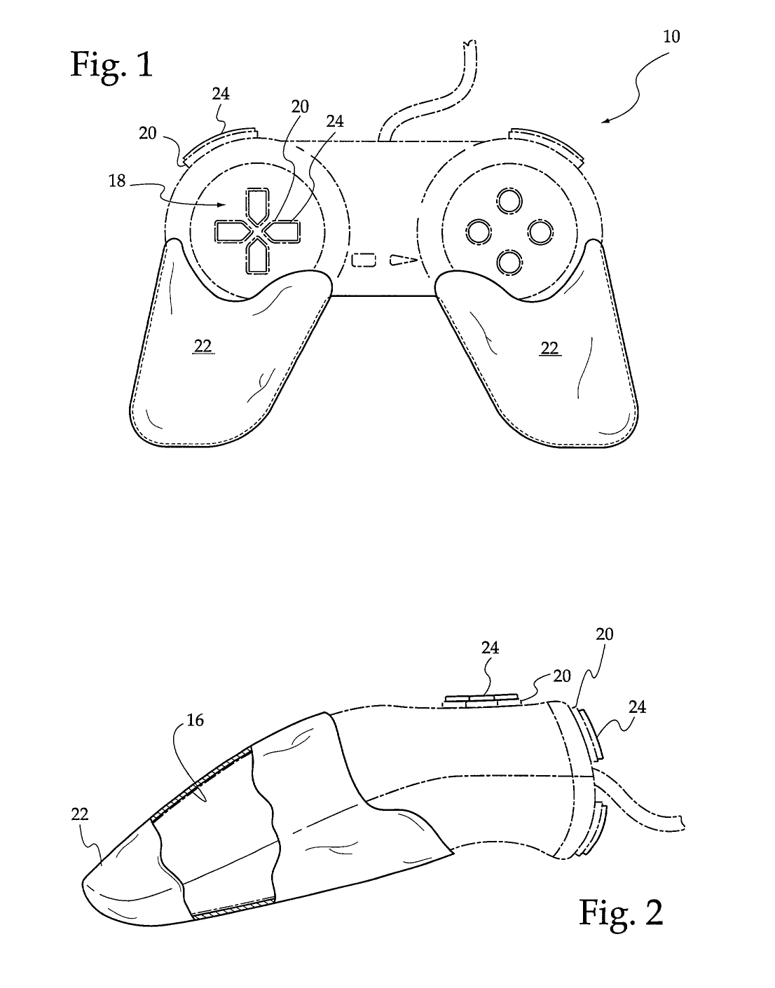

With reference now to the drawings, and in particular, to FIGS. 1 and 2 thereof, the preferred embodiment of the new and improved remote control with hand and finger cushions embodying the principles and concepts of the present invention and generally designated by the reference number 10 will be described.

Specifically, it will be noted in the various figures that the device relates to a remote control with hand and finger cushions for cushioning the hand and fingers while using a remote control. In its broadest context, the device consists of a control portion and padding. Such components are individually configured and correlated with respect to each other so as to attain the desired objective.

The control portion 12 has a generally inverted U-shaped configuration. The control portion 12 has a horizontal segment 14 and a pair of downwardly depending vertical segments 16. The vertical segments 16 serve as hand grips. The horizontal segment 14 has a plurality of game controls 18 disposed thereon. The game controls 18 are in communication with circuitry disposed interiorly of the control portion 12. Each of the game controls 18 is defined by a pressable button 20. The control portion 12 specifically includes game controls 18 on both ends of the horizontal segment 14 arrange in a manner similar to standard game controls.

The padding is coupled with respect to the control portion 12. The padding includes a pair of sleeves 22 receiving the vertical segments 16 therein. The padding includes individual pads 24 disposed on the pressable buttons 20 of the game controls 18. The pair of sleeves 22 and the individual pads 24 will comfortably cushion the user's hands and fingers during extended use of the control portion 12. Without the use of sleeves 22 and the individual pads 24, the user's hands and fingers will be subject to soreness and possible blistering.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the united states is as follows:

1. A remote control with hand and finger cushions for cushioning the hand and fingers while using a remote control comprising, in combination:
a control portion having a generally inverted U-shaped configuration, the control portion having a horizontal segment and a pair of downwardly depending vertical segments, the vertical segments serving as hand grips, the horizontal segment having a plurality of game controls disposed thereon, the game controls being in communication with circuitry disposed interiorly of the control portion, each of the game controls being defined by a pressable button; and
padding coupled with respect to the control portion, the padding including a pair of sleeves receiving the vertical segments therein, the padding including individual pads disposed on the pressable buttons of the game controls.

2. A remote control with hand and finger cushions for cushioning the hand and fingers while using a remote control comprising, in combination:
a control portion having a generally inverted U-shaped configuration, the control portion having a horizontal segment and a pair of downwardly depending vertical segments, the vertical segments serving as hand grips, the horizontal segment having a plurality of game controls disposed thereon, the game controls being in communication with circuitry disposed interiorly of the control portion, each of the game controls being defined by a pressable button; and
padding coupled with respect to the control portion.

3. The remote control with hand and finger cushions as set, forth in claim 2, wherein the padding includes a pair of sleeves receiving the vertical segments therein.

4. The remote control with hand and finger cushions as set forth in claim 2, wherein the padding includes individual pads disposed on the pressable buttons of the game controls.
